(19) United States
(12) Patent Application Publication
(10) Pub. No.: US 2005/0027996 A1
(43) Pub. Date: Feb. 3, 2005

(54) Device for copy protection

(76) Inventor: Erland Wittkoter, Bunde (DE)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/487,293

(22) PCT Filed: Aug. 22, 2002
(86) PCT No.: PCT/EP02/09392

(30) Foreign Application Priority Data
Aug. 22, 2001 (DE) 10140237.6

(51) Int. Cl. H04L 9/32

(52) U.S. Cl. 713/193

(57) ABSTRACT

The invention concerns a device for copy protection of especially optical data media such as CD/DVD. By applying additional code within the redundancy area of the logical and/or physical data media format, the data media unit receives additional identifying characteristics such as watermarks. Based on the automated error correction, the additional code data are not output by the playback and display unit. A suitable verification unit can extract the code data from the random error data, which manifest itself as white noise by circumventing the error correction. Copying of the data media by illegal, professional copy devices would lead to a removal of the additional code, and would thus be clear criteria for an illegal copy.

The present invention concerns a device for copy protection of data media units carrying digital documents, especially of optically readable data media such as CDs or DVDs.

Such a device is known f.e. from the German patent disclosure 43 11 683.

This patent is based on the increasingly growing problem of planned forgery or piracy, respectively, of valuable copyrighted content of generic data media units, such as CDs or DVDs. In contrast to copies produced by a single individual in single pieces or minimal circulation by means of so-called writable data media units, which can be recognized as forgeries due to the character of the write media without any problems, the general problem for data media copies produced in large circulation and by means of professional forgery technology consists in the fact, that forgeries thus produced cannot be easily recognized as forgeries, especially during verification outside of a laboratory environment, and thus make an effective process against piracy attempts more difficult.

In the generic prior art this problem is solved by the fact, that a characteristic and thus authenticating designation of—legally produced—data media can be produced by changing of the signal or data media designation, respectively, on the respective data media, i.e. the pits and lands on a CD, which typically cannot be taken over by an illegally produced copy and thus serve as an indication of a forgery. In the generic prior art according to DE 43 11 683, this is done by predetermined variations of the depth and width of data media identifiers, which can be recognized by suitable visual testing processes, especially by looking at it with or without a microscope, while at the same time the modifications to the data media identifiers done according to plan for authentication purposes will leave the essential digital content, such as a musical piece, unchanged.

This factor, that such modifications can not be taken over effortlessly for an (illegal) copy, is based on the fact, that illegal copies are produced in such a way, that the digital (user) content of the data media is at first read in the known way and a new data matrix for the production of the forged copy is produced with these user data. Since the generically undertaken modifications of the data media identifiers do not affect the content, i.e. they do not reveal themselves during regular reading of the digital content, they are not taken over for the production of the (forged) matrix.

At the same time there is a problem with generic prior art for wide distribution, that the production of the protection increasing markings which are visually recognizable has a comparatively high cost, accordingly demands significant investments into a production infrastructure and is therefore not available to all interested persons, who need it. Additionally, there is a problem in principle in the technology known from DE 43 11 683 in the fact, that especially with standard reader media for a CD or DVD, the modifications undertaken for security purposes cannot be read electronically or digitally, respectively and can therefore not be analyzed. It can be seen that a suppression of the modifications (which only have an effect visually) according to the generic prior art takes place due to the purely digital reading- or scanning process of the generically written CD. This factor makes the examining and testing of DVDs, especially with bad environmental intensity and with large numbers of the forgeries to be tested, impractical.

One must also take into account, that the producers of illegal CDs will be able shortly after disclosure of a visible security characteristic to copy this security characteristic. The danger exists, that the reliability of this process is of limited duration. After distribution of the technology for the CD pirates, the effectiveness of this security characteristic will change into the opposite, so that security can easily be simulated for the buyers, that the product is not a pirated product, although it was produced as an illegal copy.

It is therefore the objective of the present invention to further develop a device for copy protection of data media units carrying digital documents, that a fully automated or computerized and digital examination for an unlawful copy or forgery, respectively is possible, and which further shows, that no visible and easily discernible security characteristics can be used especially in a mobile or portable environment, respectively, where at the same time the conditions for the production of such data media units with effects increasing the protection are simplified in view of the necessary production infrastructure.

The objective is achieved by the device with characteristics of patent claim 1; additionally protection is claimed for application of the device according to patent claim 1 for the especially relevant uses CD and DVD, further for a process for the production of a digital data media unit, which is suitable for the operation according to the main claim, as well as a process for verification of potentially forged data media, which is suitable for the operation of the device according to the main claim. Other advantages of further developments are described in the sub claims.

In a manner that is advantageous according to the invention, by means for applying additional code such individualizing characteristics are applied to the data media unit, which do not affect content and thus do not affect content during playback or display, respectively, of the digital content as intended. At the same time the additional code makes it possible, that this additional code is not considered in the illegal copy process with an illegal (i.e. limited to the digital content) copy of the data media unit and is thus available for later verification purposes as a dependable and immediately accessible differentiating characteristic. This technology is deliberately in contrast to other possible code data, which are components of the digital content and which are read and copied during an unauthorized reading or copying process.

In a manner according to the invention and in differentiation from the generic prior art, the determination of an unauthorized copy happens through the fact, that the verification means according to the invention allow an immediate and therefore automated review process accessible for machine processing by immediately accessing the additional code, not only with the possibility of establishing the presence or non-presence of the additional code and thus enabling the determination of a forgery, but especially by determining a possible variation or change of the additional code vs. a predetermined original code which is stored according to the invention (and thus stored securely). With this such (advanced) misuse attempts are immediately recognizable, where a copy (partial or variation) of the additional code had been made within the framework of the misuse attempt. It is important that the verification means can undertake the immediate access to the additional code and circumvent traditional mechanisms, which typically provide, that the additional code is not considered during regular play or reading of the digital content and does not influence the content, namely already known error correction and filter modules, so that this differentiation by means of the targeted additional code is enabled for the verification process according to the invention. The general non-transparency of such a process from the user or copying view is an essential advantage of this technology.

The factor, that according to the invention a possibly automated digital verification by means of direct reading of the additional code is possible, allows for the undertaking of reviews in large volume in a simple and especially also mobile and portable manner on potentially suspicious data media units, so that a tool is available for suitable enforcement agencies, with which an unlawful violation can be determined immediately, with proof and causality, which provides a basis for immediately following, effective proceedings against violators, f.e. searches, which are only possible with concrete proof of unlawful behavior.

In a preferred model of the invention, the verification unit can be publicized, since a correlation within an additional code can be produced by the Public/Private Key process, without the thus disclosed information leading to a decreasing of the security process and its compromising, respectively.

Within the framework of the present invention, the concept of digital documents or of an electronic document does not encompass only music (audio) and video data, which are actually especially endangered by forgeries, but especially also computer games, computer software, digital text, picture or multimedia data, which typically have proprietary meaning and thus represent property worthy of protection.

For a data media in the present invention, not only the already mentioned CD, DVD or mini disc is suitable; reels with digital data (f.e. DAT) or such record- or reel-like storage media, which typically are used for the distribution of proprietary valuable digital data, including future possible holographic or such storage media, are suitable for the present invention.

The additional code within the framework of the present invention can be roughly divided into two parts: according to the invention, additional code within the framework of the logical structure of a data media unit is possible, where the logical structure is seen as the format structure or organization of the media unit, respectively, as it is present in the form of frames, sectors, tracks, etc. in the manner designed and typically predetermined by norms or such conventions (perhaps Red Book for CDs or CD-DA or music CDs, respectively, in the narrower meaning or Yellow Book for CD-XA or CD-ROMs, respectively).

Within such a logical structure, the provision of the additional code according to the invention can be done in multiple ways, perhaps in the user data area (as long as the original digital content remains unchanged in the end result by the additionally present correction mechanisms, i.e. being originally reconstructed, corrected, calculated or interpolated), additionally in (typically redundant) error correction and/or control data areas (also called sub-code data area), further in possible additional header data or lead-in-lead-out data areas (i.e. in input and output areas), etc. It is correct, that with applying the additional code in this way according to the invention the condition is preserved, that the digital content signals to be displayed for a user are not influenced by this additional code, i.e. the respective additional code measures in the logical structure undertaken in a purposeful manner are either suppressed within the framework of the present error correction and redundancy structures relative to content, or are not considered in other ways.

The additional data suppressed within the framework of the logical structure can be corrected before output by the inherent redundancy data on one hand, on the other hand the data fields can be used without further error correction, which are designed for further expansion of the standard according to the respective specifications and which will be used actively only for expanded formats, such as f.e. sub-code channel R to W in the corresponding control data area of a CD.

A second essential objective aspect of the provision of the additional code according to the invention is found in the fact, that it is designed to be within the physical structure of the data media unit, but outside the logical structure. This means, that the modifications according to the invention for data media identifiers, readable for reader units, are undertaken, which are outside the format and organization structure of the data media unit. They could be, f.e., additionally placed pits or lands, respectively or deviations of them, which are detectable by a generic (laser) reader head, or such data identifiers, which deviate from pits and lands relative to the standardized format relative to measurements, and which thus no longer count a normal digital identifiers, but which, however, (and in delineation from the generic state-of-the art of the technology) can be collected by the typical reader sensor technology of a CD of DVD as signals and can be detected for analysis within the framework of the verification or the verification, respectively. As a typical real example physically very short markings (identifiers) relative to the pits and lands of a CD are on the data surface, which lead to correspondingly other (short) detection signals, and have a rather defective character relative to signal, so that they are suppressed or blended out by traditional error correction mechanisms during playback, however they are readable or able to be analyzed for verification purposes by the verification media according to the invention.

Within the framework of the present invention, the playback or display unit, respectively, is a medium for output, for storage, for copying, for processing and for transfer of data over a data transmission network such as the internet, which is understood as a typical consumer playback unit for reproducing the digital content, and in the case of CD or DVD a commercial CD-, DVD player, or of CD-ROM or DVD-RO, respectively, which are contained in commercial PCs, and which shows in otherwise known way a (laser) scanning unit with coupled digitalization, buffering and error correction, in order to reproduce data media of inferior quality in a usable way. In this context, error correction and filter units according to the invention typically exist in known mechanisms, in order to compensate for (based on pressing errors) data or surface errors, including scratches, dust, hair, fingerprints or such, where besides the mechanical effects the designed error corrections normal for CD and DVD are provided, based on a very high redundant data volume. Prevalent error corrections begin with the CRC, with the suitable code (ECC or EDC), respectively, or with correctly used reconstruction processes such as CIRC or ACIRC.

Depending on the procedure according to the present invention, the application media according to the invention exist in (typically software technology implemented) devices for input or anchoring of the additional code for the production of a CD or DVD (i.e., a common step for the production of the glass master of the matrix takes place as production master) or the application of additional code occurs independently from the otherwise known production of the matrix with the digital original content, by previous or subsequent manipulation either of the matrix or the respective pressed end product, perhaps by means of a laser or magnetic unit for the production of the modifications according to the invention of the physical structure of the data media unit.

The process according to the invention also provides for the production of a digitally effective watermark for copy protection or authentication control, respectively, where according to advances with suitable content allocation and linkage, respectively, of data with the additional code a number of such watermarks can be ascertained and determined, so that, as designed in the invention, a hierarchy effective security over several levels of security (preferably differentiated by a degree of secrecy of the respective linkage with the additional code) is possible.

As designed in further developments, the realization of this advance of the invention is especially elegant, if a data set individualizing each CD, f.e. in the form of a serial number, which can be produced in a known way, is available and thus, similar for recognition of forged money, an examination of the multiple presence of the same digital identifier, deducted from serial number and additional code is possible.

This idea with the conception of individual watermark acquisition and calculation methods can be developed as a system to a platform, which then allows optional combinations and security levels, which increase security, so that even if the security architecture according to the invention should be undermined by a copy mechanism operating at deeper levels, the recognition of a forgery is nevertheless possible. As a result, the present invention for the first time creates the possibility, to recognize unlawful copies even of data media produced professionally in large numbers with little additional production and monitoring costs and thus to be able to begin immediate abatement measures, without requiring special optical devices or a trained eye, as is necessary in the prior art, or even requiring costly copying proof in a laboratory environment, to find proof of an unlawful copy. It rather allows the production of the device according to the present invention with a simple verification structure, which can be automated, which offers the potential to suppress the copying nuisance, which is detrimental to the public and debilitating to production, once and for all.

Further advantages, characteristics and details of the invention result from the following description of preferred models as well as through the diagrams; they show in:

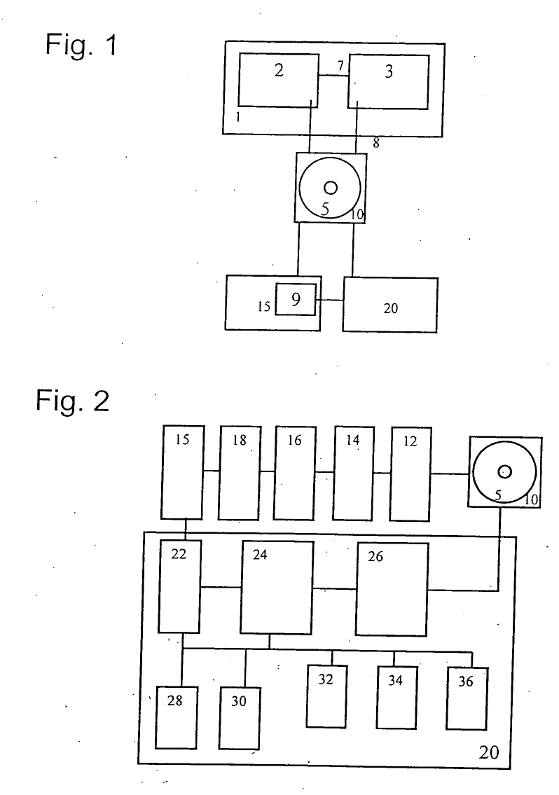

FIG. 1: a schematic block diagram of the production, playback and verification units according to the first, preferred model of the invention,

FIG. 2: a schematic block diagram of a playback unit and a verification device according to the first preferred model of the invention,

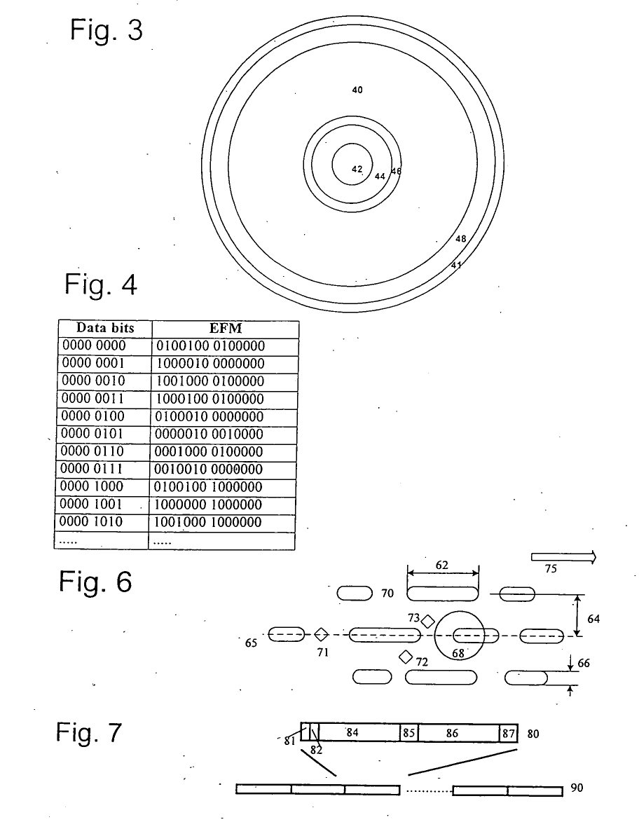

FIG. 3: a schematic diagram of the CD/DVD with the lead-in/lead-out and user data areas,

FIG. 4: a sample excerpt from the EFM code table,

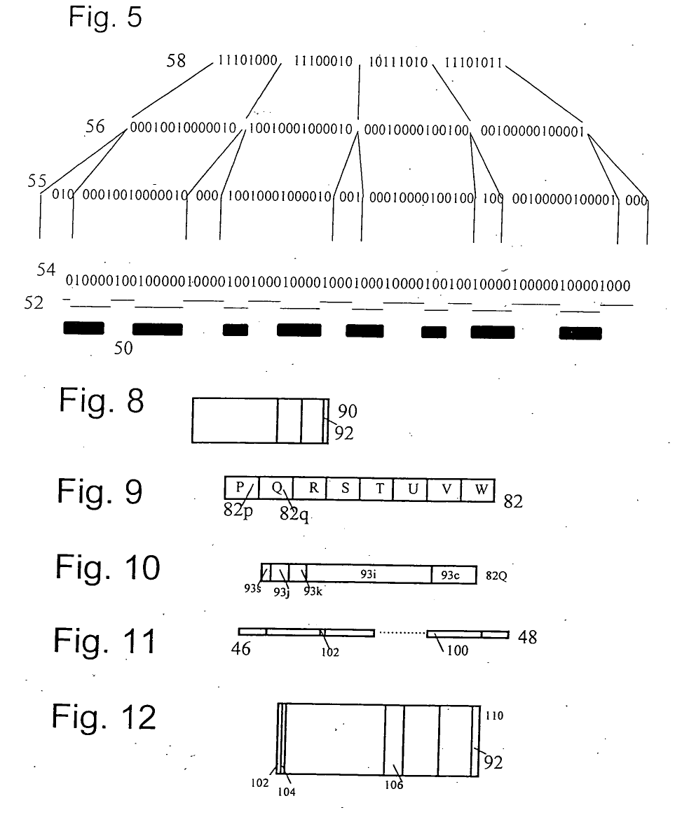

FIG. 5: a schematic diagram for the conversion of bytes to the pits contained on the CD,

FIG. 6: a schematic diagram of the CD/DVD with a description of the pits/lands and of defect-like signal elements contained in them,

FIG. 7 a schematic assembly of a single frame on a CD,

FIG. 8: a schematic assembly of the data areas of a sector of a CD,

FIG. 9: a schematic assembly of sub-code channel bytes on a CD,

FIG. 10: a schematic assembly of a sub-code channel Q over a sector,

FIG. 11: a schematic assembly of a music CD (CD-DA), which is formed of music tracks,

FIG. 12: a schematic diagram of the CD with the additional header data according to the CD-ROM (Yellow Book) format,

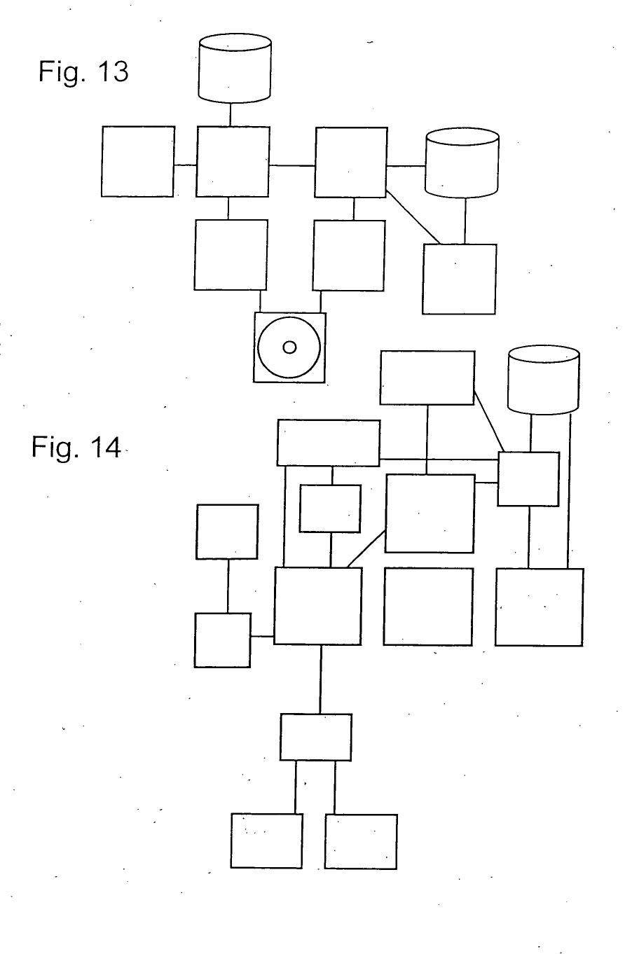

FIG. 13: a schematic block diagram of the units, which are suitable for the production of the CD with additional code according to a first, preferred model of the invention,

FIG. 14: a schematic block diagram of the components with the individual units, which are suitable for the production of the CD with the additional code according to a preferred model of the invention,

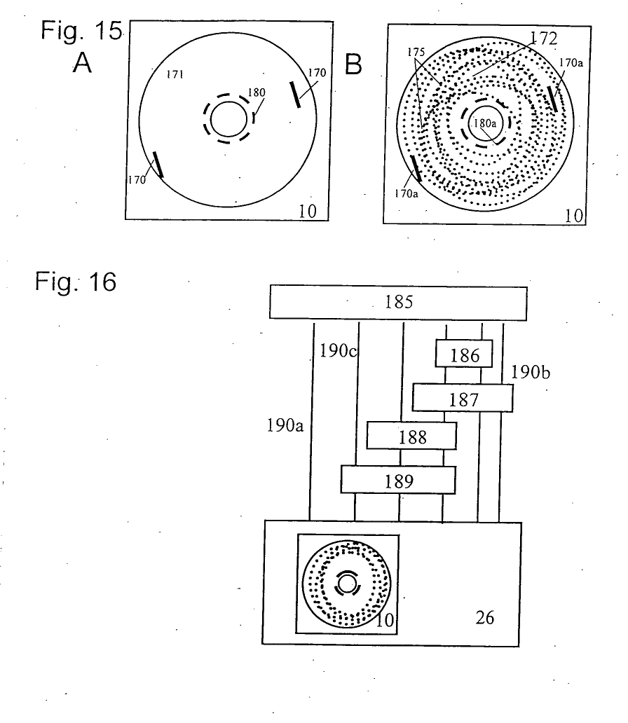

FIG. 15: a schematic diagram of additional code, which can be contained on a CD in the form of watermarks, a serial number or such,

FIG. 16: a schematic block diagram for the design of the driver for reading the additional digital code according to a first preferred model of the invention,

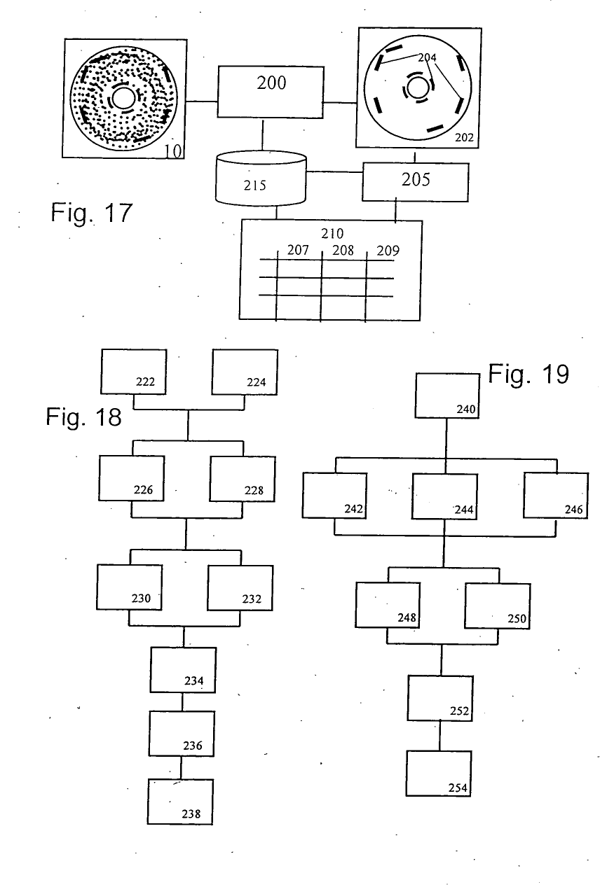

FIG. 17: a schematic block diagram for the description of a watermark separation unit, with which several watermarks can be formed from the additional code data contained on the CD,

FIG. 18: a schematic block diagram of a process for the production of a watermark, where a watermark is connected to a serial number according to the data,

FIG. 19: a schematic block diagram of a process for analysis of a watermark, where a watermark is connected to a serial number according to the data,

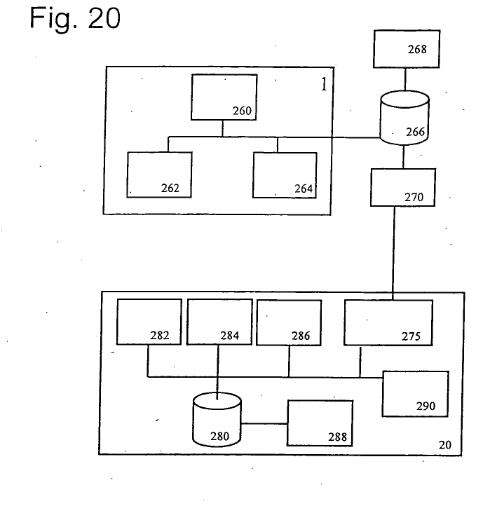

FIG. 20: a schematic block diagram of a security platform, where security-enhancing components are interchangeable.

FIG. 1 shows the schematic diagram of a first preferred model with the essential main function components of the present invention, namely a production unit (1) with, on one hand, media for applying digital documents, implemented in otherwise known technology for the production of digital data media, perhaps by means of glass master, and on the other hand media (3) for applying the additional code, where these media affect the data media unit (10) directly, or by means of the connection (7) to the unit (2), where, at a suitable position in the logical structure of the digital document, the additional code is inserted into the application unit (2) before the final production of the data media unit.

Moreover, as can be seen from FIG. 2, the data media unit produced according to the invention works together with the digital document and additional code in otherwise known manner with media for output (15), which can f.e. be implemented as CD or DVD player and, typically by mixing hardware and/or software components, reproduce the pure content of the digital document and blend out, correct or interpolate physical and/or logical errors or modifications. Additionally, means for verification (20) are designed for use by authorized users within the framework of the invention, which, in a manner to be described later, show a functionality which clearly go beyond the playback media (15) and are especially in a position, to extract the additional code in the desired manner for detecting unlawfully produced copies within the framework of the invention.

Moreover, FIG. 1 clarifies, that the playback and display unit (15) can be expanded by means of communication- and operation control (9), which can query the media for verification (20) in a manner secure against manipulation, if the data media is an authorized specimen. Additionally, further control information can be extracted over the unit (20) from the additional code data and can be transmitted to the communication- and operation control (9), such as f.e. limitation of the user rights, such as the number of copies, which can be legally produced from the data media, or the right, to offer the digital document in a set number for exchange over the internet or such. The output media would activate or suppress the user rights or user limitations, respectively, allocated to the electronic document within the playback-, display-, copy or data transmission modes.

FIG. 2 clarifies, by means of a single station computer system, how the present invention can be implemented and expanded with modules and components of a commercial PC. According to FIG. 2, a digital document (5) is read by a data media unit (10) by means of a data media reader device (12). Thus, for a CD or a DVD, the reader device reads by means of a laser or a photo diode or such to recognize signal identifiers, which are applied to the data media unit and are represented as digital data. The measure analog signal is transformed into a digital signal by means of an AD converter and changed into a sequence of 1 or 2. In order for the processor of a PC or a player to be free from correction by hardware and data media associated errors, defects or contamination, the errors are corrected immediately after reading by special error correction processes of a correction unit (14) implemented in the hardware. An example of this hardware implemented error correction would be the use of a low-pass filter for removal of errors in the reflection and absorption zones, which are smaller than the typical pit lengths or the gaps between them, the so-called lands. Moreover, a conversion of digital signals by means of EFM signaling can be implemented by the hardware, so that the byte data can be reconstructed correctly even with individual bit errors.

Additional corrections can be executed by a correction unit (16) implemented in the software, which can be used to detect further errors in the digital data by processor operations and which is also in a position to correct the respective defective data depending on the severity of the error. The software error correction is used, when different physical and logical structure formats are contained in the data media unit.

Depending on the data media reader hardware used, corrections to the smallest self-contained data units, the frames, can be executed automatically hardware-related in the correction unit (14). Since the function of the error detection and the error correction can be contained in the software as well as in the hardware, they can be offered and used in an interchangeable manner in both variations, while a software-implemented error detection and correction can be used for improving flexibility relative to the reading of different formats.

Hybrid soft- and hardware implementations are also deployed, where the error detection is executed automatically by a hardware implementation, while the more infrequent error corrections are executed by the software. After correction the data are transmitted for output by a regular driver (18) adjusted to the special software interface of the hardware, or, corresponding to a processor centered operating sequence, the driver (18) is requested to accept the data from the data media (10) contained in the data media reader device (12) by means for output, storage or processing (15) by corresponding software components and requests in the driver interface.

With the verification unit (20) according to the invention, the expanded data media reader device (26) reads the data contained in the data media unit (10) without the error correction processes contained in regular operation and/or with high sensitivity, so that the defect-like signal code can also be recorded.

The data read by the expanded data media reader device (26) can be improved or made more easily detectable by means of additional low-pass filters and/or converted at once into a digital signal, so that a digital signal essentially untouched by error correction measures is delivered to the expanded driver (24) or that the data are requested by the driver (24) in the usual manner.

The data are requested in the verification device (20) by a validity review unit (22) and are further processed. There the additional code is separated from the content-related code and watermark data and/or additional serial numbers and/or encrypted additional data are extracted in order to obtain final information as to validity or forgery of the hidden security characteristics by using additional verification processes.

By the subsequent output of the verification result in an output unit (28), the reviewer can arrange for further measures. Thus the data obtained by the review can be stored in an archive unit (30) in the case of a detected illegal copy for reasons of securing proof. Moreover, additional data can be added by an input unit (32) to the proof securing protocol. In addition, a digital signature unit connected to the verification module can be digitally signed for increased data integrity of the proof securing protocol together with qualified time stamp and additional smart card.

Either after detecting a digital document or after user input in (32), different parameters or extraction processes, respectively, for the validity review unit (22) from the parameter storage unit (34) or different drivers from the driver storage unit (36) can be loaded instead of the driver (24). Correspondingly developed, the selection process after reading of a few identifying data from the digital document can also happen automatically.

FIG. 3 shows a CD or DVD, respectively, with a central hole (42) and an area for the drive and pressure mechanism (44) of the player. The user data contained on the data media unit are deposited in a groove beginning on the inside and running in a spiral to the outside in the so-called user data area (40). Each CD has additionally an entry area or lead-in area (46) where control or meta information is deposited. The user data area is terminated according to the Red-book specification by an exit area (lead-out area) (48), before the non-recordable edge (41) of the CD is reached. The multi-session CD permits the CD-ROM to contain several lead-in and lead-out areas, to that the burning of a CD does not have to be executed in a one-step process, but can be done in several steps, where, in such a case, a new lead-in/lead-out area has to be recorded on the CD. Since these areas each can have several MB and the data contained therein are subject to a strict format, where the data area is not completely utilized, a part of the additional code can be integrated into these areas, without the software, which analyzes these areas, registering these additional code data. The table in FIG. 4 contains an allocation of byte data to a 14-bit wide data modulation for an individual data byte corresponding to the EFM (Eight-in-Fourteen Modulation). The values contained below the EFM interstice are only 256 combinations of the total of 16384 possible bit combinations. Individual bit errors in the 14 bit display can be converted to the data bit with respective allocation processes, which then very probably correspond to the associated data byte. Thus 1000010 0100000 corresponds to the bit value 1. The processes for allocation are f.e. designed in such a way that they can allocate the byte value 1 to a 1100010 0100000.

A regular driver with an appropriate error correction would not differentiate between the two EFM codes and would thus give the byte value 1 to the requesting components. Since 1 pit error can possibly have different causes, pit changes can be used for hiding code 2 or 3, so that a reliable allocation to the original byte for regular error correction is still possible.

In contrast, a more sensitive data media reader unit (26), by circumventing possibly present error correction, can extract these additional data from the EFM modulation. Since a majority of the pits/lands and thus of the EFM changes can be traced to actual reader and material errors, the hidden additional code data perceived as white noise are contained in a batch of a further data batch ascribed to real errors and contaminations.

FIG. 5 shows, how the final digital signal data (52) are produced in the form of an unstructured appearing linear chain (54) of bits (“0” and “1”) on the pits (50) as a chain of reflection and absorption zones on the CD, while a synchronization characteristic consisting of 24 bit as pits/land chain enables the classification of the bit sequence by the fact, that a classification process can subsequently be used. By the synchronization and by the disconnection into 14-bit modulated data with additional so-called 3-bit wide “merging bits” (55), the 14-bit modulated data (56) can be extracted. By an allocation and with a bit error correction contained therein the 8-bit data can be gained from the 14-bit data as byte values (58).

In FIG. 6 the grooves (65) and pits (60) and lands (70) are represented in an enlarged section of a CD, which turns in the direction of the arrow (75). The pits have a width (66) of approx. 0.5-0.6 μm and a length (62) of 0.83-3.05 μm. The focused laser (68) with a red light has a wavelength of 780 nm. The depth of sharpness of the laser beam is approx. 2 μm, so that due to the diameter of the laser beam (68) of a regular CD device the defects of type (71), (72) and (73) cannot be registered. These defect-like characteristics can be on the groove (71) in a lands area, between the grooves (72) and in the vicinity of a pit beginning or end area (73), respectively.

By a laser beam with a smaller wavelength or a non-linear focusing process or a non-linear photo detection device the defect-like pits can, however, be registered and can be used as additional code independent from the code used with the digital document.

The data on the CD are combined, as described in FIG. 7, in the smallest data organization unit, the frames (80). Each frame begins with a 24-bit synchronization area (81) and 3 merging-bits. It is followed by 1 control byte (82), which is represented in an EFM byte as are all other following bytes and is separated by 3 merging-bits. The first user data area (84) consists of 12 bytes followed by the 1. (1^{st}) level EDC/ECC correction data (85), consisting of 4 bytes. The second user data area (86) consists also of 12 bytes, followed by the 2. (2^{nd}) level EDC/ECC correction data (4 byte) (87). This frame produces a sector (90) by stringing together 98 frames.

FIG. 8 describes a schematic assembly of a sector (90) where the 2.352 byte user data contained in the user data area (94) are distributed corresponding to the frame area (84) and (86) described in FIG. 7. The 1^{st} level EDC/ECC data are contained in the EDC/ECC data area (95) and the 2^{nd} level data are contained in the EDC/ECC data area (97). The also distributed 98 byte control data (92) are also called sub-code channel.

FIG. 9 contains a single sub-code byte (82) contained in every frame. Corresponding to the convention, the bits are marked with P to W. The sub-code channel P (82p) contains a flag, which indicates at which address within the tracks the music or data begin. The sub-code channel Q (82q) permits the addressing of a sector on a disc corresponding to a manner specified in the Red-Book.

FIG. 10 describes the 98-bit long sub-code channel Q (82q), which consists of 2 synchronization bits (93s), a 4 bit long type information (93j) for content and 4 control bits (93k) for the then following 72 bit long data bit content (93i). Subsequently 16 bit for error detection (CRC) (3c) are added pro channel.

The error detection and correction bytes contained in (95) and (97) and the CRC bits (93c) contained in the sub-code channel permit a change of the user and control data, so that a regular driver receives the data without error during automated error correction, while the presence of the error and the additional information resulting from it can be extracted as additional code by a verification unit.

As with the EFM error situation, the verification unit cannot recognize the error bits without additional data, which are traced back to the additional code. Furthermore, the sub-code channels R to W are not used for a music or data CD (CD-ROM), so that almost 12 MB can be deposited onto the CD relative to the total CD.

A music CD is assembled according to FIG. 11, where the CD is assembled in tracks by the sub-code channel P. It contains a lead-in area (46) in the beginning and a lead-out area (48) at the end. Between these, up to 99 music tracks can be located. Between the musical pieces/-tracks individual free or empty sectors (101) can be deposited, which contain no user data, but instead additional code data.

FIG. 12 describes a schematic assembly of a CD-ROM sector (110) according to mode 1 of the Yellow-Book specification. Due to higher requirements in relation to freedom from errors of the user data, the user data area (94) is further divided. Additionally, a 12 byte sync data field (102), a 4 byte header data field (104) and a data area limited to 2048 byte for user data (105) is inserted. The remaining 288 bytes serve for the additional CD-ROM-specific error detection and correction (106).

As with the intentional change of original data with the production and description of this situation in the two previously represented examples, the user and header data provided with the additional code are reconstructed by the data fields (95), (97) and (106) during use of the inherent error corrections, where a regular driver can ignore this additional information contained therein and give an error-corrected output, while the verification unit (20) can recognize the additional data and extract them together with other error and defect data coincidentally contained therein.

FIG. 13 contains a block diagram for description of the production of a data media unit (10) provided with additional code. The additional code data are produced as watermarks, as serial numbers or as an encrypted character string in the additional code data production unit (130). The parameters used for this and/or the data resulting are stored in a parameter data storage unit (132) and/or transmitted to a unit for generating review parameters (126), from which the verification unit (20) can actualize the respective data in a timely manner either over the internet or the data media.

The contained music data ready for publication are retrieved f.e. from a music data storage unit (125) by a merging unit (120), which is responsible for the total generating of the data contained on the data media units, where this unit is responsible to bring together the music data and the additional code data before the creation of a respective glass master or a matrix, respectively. At the same time the EFM codes not yet carried out are taking place. Subsequently the EDC/ECC error correction values are calculated in the generating unit (122) and a corresponding pit code is produced on the glass master (matrix), so that the CDs or DVDs are produced according to generating processes known from prior art, where the CDs are produced from polycarbonate with a reflective metal layer, where the additional code, serving among others for identification and recognition of pirate ware, are contained in the redundancy area of the data.

For simplification in administering these additional codes during generating and later verification, an input unit (135) is provided, where additional administrative data can be added to the watermarks, serial numbers or encrypted additional data in the data storage and for control of the generating of the respective data.

As an alternative for inserting additional code in the merging unit (120), a post-processing unit (124) can be executed in an additional step, f.e. by a laser, which burns the additional signaling characteristics onto the optical data media at a previously calculated position, in order to produce the situation of a defect-like signaling.

FIG. 14 shows a block diagram consisting of components, where several additional code data output units (144) can be provided and where the generating of watermarks (150) takes place behind an especially protected security installation, f.e. an optional firewall (145), where the delivery of the respective additional code data takes place only after a request from a data input station (142). The protection of the components behind the firewall results from the necessity, of protecting especially critical data, which enable the copying of watermarks or such and eventually a legal appearing piracy product, from dissemination or betrayal, respectively.

The data are retrieved by the session management of the server (140), where a user has to be known by the user management (146), before further use actions can be released in the session management (140) after review of the user password by the user access management (148). There data released to the output unit (144) can either be further automatically evaluated, transformed or further calculated within the framework of a work flow. The additional code data originate in the additional code data generator unit (150) or in an intermediate storage, f.e. from the one in the session management (140) or such.

For provable deposit of the data contained in the additional code data generator unit (150) the data in the example in FIG. 14 are signed by a further certification unit (152), before they are deposited in the data storage (155), where this step optionally can be bypassed. For generating and for use of private or public encryption an encryption generation and user unit (154) is provided, where either the additional code data generator unit (150) is provided with encryption data or the private encryption data for watermark parameters, serial numbers or such are used.

Additionally, all important processes can be recorded by a log file generator and storage unit (164), where for additional increased security an external monitoring unit (162) is added, whose data are also contained in the log-file and are not subsequently changeable. The data thus created as a qualified protocol in a certified log-file output unit (160) can without interruption prove the integrity and freedom from manipulation of the server unit.

Although the component model permits the distribution of the processes to individual independent computers, which communicate with each other over a network, the consolidation of individual tasks in a smaller number of computers is reasonable, so that the flexible distribution connected with it can find a corresponding application through a suitable configuration management (165), as in the described example.

In contrast, FIG. 15 shows schematic structures of a data media unit implemented in the previous example as CD or DVD in two reader or observation levels, respectively: the left view clarifies a data media unit (10) with a digital data area (171) as well as an additional area (180) with the serial number or other encrypted additional data, respectively; the reference characters (170) indicate two watermark data areas produced in the otherwise known manner.

The right view of FIG. 15 clarifies a deeper technical reader level of the data media unit (10), namely without (largely hardware based or automated, respectively) correction especially of the user surface in the area of the digital data 172 for always present, randomly arranged impurities, errors, local deviations or such (designated in the following as “white noise” (175)). The reference characters (170ₐ) and (180ₐ) designate the also present additional code data, as they are contained in the left view, however, in the right display they cannot immediately be distinguished from the data of white noise (175).

As FIG. 16 clarifies with a schematic view of a driver unit combining hard- and software elements for implementing the verification media (20) (compare FIG. 2), it is now possible, to selectively evaluate the inevitably present physical conditions on a data media unit (FIG. 15) and thus to secure the desired verification purpose within the framework of the invention.

Thus especially the unit (188) and (189) offer the possibility, to undertake error detection and correction based on hardware (i.e. in real time, but comparatively inflexible), but according to each applied additional code selectively, i.e. able to be dialed or able to be switched off. The corresponding is valid for the software implemented error detection and correction designated with the reference characters (186) and (187), so that an infrastructure for maximum use of the physical conditions of the data media surface are available with the designated unit and for a downstream data interface (185) for an expanded data media reader unit (26) in a highly flexible manner.

FIG. 17 clarifies the system connection: a device (200) for filtering the white noise (FIG. 15) purges the data media (10) controlled by a suitable parameter and storage unit (215). The output according to data of the storage unit (200) namely the data media illustration (202) purged of the white noise, which still contains the additional code data according to the invention (204), is examined in the unit (205) selectively for the respective additionally applied code information, and they are then distributed in independent review criteria (depending on the unit (215)) and deposited in the table (210), as shown in a schematic. Expressed more exactly, a compilation along independent review criteria consisting of parameters for characterizing watermarks (207), serial numbers (208) and additional interstices (209) takes place with the advantageous effect, that a clearly defined logical structure of the different watermarks or markings, respectively, and their associated review criteria is available. This results in the fact that the security of the present copy protection process is even then guaranteed, when some of the additional data components or watermarks, respectively, are decrypted or revealed, since the content summarized in the table is constantly expanded by further review criteria, which normally are not complete and can be totally improperly implemented.

FIGS. 18 and 19 clarify the generating (FIG. 18) of the multiple watermark information and their evaluation and review (FIG. 19), respectively, by means of the indicated flow diagrams; the associated explanations of the processing steps in the attached reference character table, which together with the additional reference character explanations are regarded as belonging to the invention in the present description, are referenced.

As far as the processes according to FIGS. 18 and 19 are affected, it is notable, that the selection of the encryption creating a relationship between the watermarks and the serial numbers, respectively, can be variable, random and especially rule based, respectively, as well as the selection or positioning, respectively, of the concrete application prototype of the additional code.

This variability is also found in the concrete verification process (FIG. 19), with the parallel executed steps (242) to (246), which correspondingly enter into the actual extraction and subsequent verification as input parameters. FIG. 20 finally converts the generating and verification steps clarified in FIG. 18, 19 into a correspondingly implemented device according to a further preferred model of the present invention, which, in further development of the generic structure according to FIG. 1, enables special units for variations in the creation of the watermarks and their allocation, respectively, as well as correspondingly on the verification side a large impact and parameter latitude for maximizing the security enhancing measures. A—necessary and in view of the complexity and variant latitude according to FIG. 20 complex—communication between the units is implemented according to the invention by a suitable, preferably mobile implemented communication interface (270) and (275), which especially in view of misuse is suitably secured during communication. Thus the appropriate concretely set security related parameters converge in the data storage and are transmitted to the equivalent unit 280 on the side of the verification unit.

The additional code data are divided into 3 categories: the watermark-like, the serial number-like and the encrypted additional data-like data.

The serial number data or unencrypted additional data, which can be added to the serial numbers as additional characteristics, are data, which f.e. are deposited at a defined position (data position), in a defined sector or such in preferably connected manner in an unencrypted way on the data media. The meaning of the data, which can be read in these fields, are made known to the verification unit by process instructions and/or by parameter sets.

The encrypted additional data, like the unencrypted serial number-like data, are also stored in defined data media positions and/or sectors or such, where the only difference is in the encryption of the respective data set.

In the unencrypted as well as in the encrypted additional code data, additional data such as parameter, process instructions or such can be contained, with which the hidden watermarks can subsequently be extracted.

The decryption of the encrypted code data sets can be done either by publicly available public keys, perhaps in the case of data to be protected against manipulation, such as for use limitation of the data media.

Further keys can be later applied for enhanced security and reliability of the process to other fields, already prepared in reserve, so that a review can be executed even when respective secret hints for exact implementation of the device have become known.

The parameters thus obtained from the additional code data in unencrypted and encrypted form can be converted into watermark data, and the data media reader unit can also subsequently search for these data without all data, which are detected as white noise and perhaps resulted from pure material and surface errors, have to be read by the data media.

The watermark is a signal that is created during uncorrected, with unintentional material or surface or sensory errors afflicted, reading of the data. In this way, the added additional code data are to be regarded as watermarks, because during a very exact scanning of the surface of the data media and even with knowledge of the data media format, they are not recognizable.

The use of a robust watermark results from the application of a watermark generating process already sufficiently known from prior art. The serial number-like and the encrypted additional data do not absolutely have to be contained in the redundancy area of the CD/DVD data media, but can also be deposited in fe. the additional sub-code channel R to W or the lead-in or lead-out areas outside of the evaluation areas of other programs/processes. Although this procedure would also be possible for the watermark, the partial storage of the watermark in the redundancy area of the data media offers enhanced security, so that during an automatic correction of error data by a non-authorized copy site, which is not informed about the watermark, the watermark would also be damaged.

Furthermore, very few data, which f.e. are added after the CD is pressed by the process known sufficiently according to prior art, can be added and eventually be accessed by an additional encryption of the data thus applied of an individualization free of manipulation of the individual CD, so that these additional data can be reviewed by the verification unit in a manner according to the invention independent from a laboratory environment.

There is no obvious differentiating characteristic for the verification unit between a material or surface error and an additional characteristic possibly artificially added or a corresponding additional code, which can be used within a watermark or such.

Thus, every naturally occurring defect, which can be detected or read by the verification unit, can be consulted for the determination or authenticity of a CD or DVD, respectively, and can be linked to a serial number or other additional and perhaps encrypted data by linkage within a predetermined process. In this context, the additional characteristics do not have to be applied artificially as defect-like characteristics, but can be selected and thus established by the definition of a predetermined selection and detection process selectively from inherently present defect positions (data media identifiers or defect-like signal elements, respectively, in the context of the invention). Thus a watermark can already be defined and labeled by establishing of parameters within the selection process, which does not come into existence only with externally added data or characteristics, as is the case in prior art. An easily detectable watermark, hidden naturally without any additional effort but with knowledge of predetermined parameters, instructions and use of suitable verification or sensor media, is thus created through the always accidentally created defects.

Besides the already present defects additional well-placed artificial characteristics can be inserted, but which then show a pattern not recognizable or an inner mathematical relation not recognizable with the naturally present defects, without exact knowledge of the selection process.

In contrast to the quick determination, which can be easily automated, what areas should have watermarks or which areas are to be used for this, the copy of already present surface defects poses a much tougher generating technology challenge for the CD pirate then for the authorized original producer of the CD.

By using existing material and surface defects in the definition of the watermark a definition or version of the watermark, which is basically not reproducible is created, since the actual definition is located within a secret definition process, which is easily changed by parameters.

The parameters used can also deposited on the CD or DVD, respectively, since their meaning can only produced by the verification unit. Furthermore, by varying different verification processes it can be easily determined which processes were made known for the recognition of additional characteristics, since a very small number of successful matches and a simultaneous non-agreement of the characteristics within other verification processes are a clear indication, that the matching characteristic processes were in all probability discovered by pirates.

The watermark made recognizable by use of the parameters thus represents a document, which can be signed digitally by the use of known digital signage processes and whose values were deposited within a predetermined and even publicized area of the CD.

The defect-like data used or contained in a watermark or in the additional code can also be subject to change due to contamination, scratches or other environmental factors, so that the added or used defect-like additional characteristics can show an inner redundancy, whose reliability can be increased by an EFM-like code or modulation, by CRC or EDC/ECC-like correction data or by a CIRC or ACIRC-like reconstruction processes.

An illegal copy of a digital media such as a CD or DVD remains recognizable as an illegal copy forever by means of the device according to the invention, the use of the same and by the use of the process according to the invention, and this is independent from future advances for the generating processes of CDs or DVDs, respectively. For this reason, the race of generating technology between original producers and organized pirates by use of the technology in the invention can be viewed as decided for the time being and possibly permanently due to the high costs of the technical circumvention of this protective process. Due to the easy handling of a corresponding review technology, implemented especially with conventional PC technology, the random review of samples of CD/DVD products offered for sale can be expected within the framework of the obligation of care by sellers, re-sellers or middle-men, in order to ascertain, if illegal wares are involved. Thus the market for illegal digital goods can be limited with existing means.

The reliability of the copy protection process according to the invention results from the fact, that even a CD pirate supplied with professional generating technology and copy technology is not in a position to clone all defect-like signals, of physical origin or based on deviation from the logical format, without errors. The absence of the additional code thus provides immediate proof of illegal samples of a data media produced in a non-authorized manner.

### Table of Reference Characters

The following table contains supplementary description of the reference characters in FIGS. 1 to 20 and is a part of the present invention and disclosure.

| Reference | |
|---|---|
| Character | |
| Clarification | (Description) |
| 1 | Generating unit; means for production of a data media unit with additional code |
| 2 | Means for application of digital documents onto a data media unit |
| 3 | Means for application of additional code data onto a data media unit |
| 5 | Digital document; electronic document |
| 7 | Means for inserting additional code data into a logical data structure |
| 8 | Means for direct application of additional code data onto a data media unit |
| 9 | Means for communications- or operation control |
| 10 | Data media unit; means for storage of electronic documents and of additional |
| | code data |
| 12 | Data media unit reader device; means for reading of digital data from a data |
| | media unit |
| 14 | Means for error detection and correction, which is implemented in the hardware |
| 15 | Means for output and representation of digital documents |
| 16 | Means for error detection and correction, implemented in the software |
| 18 | Driver of data media reader unit (12); means for reading data from the digital |
| | document |
| 20 | Verification media; means for verification of a sample of a data media unit |
| | produced in an authorized manner; means for detection of an illegal non- |
| | authorized production of data media to be tested |
| 22 | Validity review unit; means for review of criteria, which are linked and contained |
| | in the additional code data |
| 24 | Expanded driver of (26); software interface for reading of additional code data |
| 26 | Expanded data media reader device; means for reading of additional code data |
| | from a data media unit |
| 28 | Output unit; means for output of data of the verification unit |
| 30 | Archiving unit; means for storage of results of a review process |
| 32 | Input unit; for input of data into the verification unit |
| 34 | Parameter storage unit; means for storage of parameter data, which can be used by |
| | (22) and (24) |
| 36 | Driver storage unit; means for storage of driver data, which can be used by and |
| | instead (substituting) of (22) |
| 40 | User data area of a CD or DVD, respectively |
| 41 | Non-recordable edge of the CD or DVD, respectively |
| 42 | Center hole of the CD/DVD |
| 44 | Area for the drive and pressure mechanism of the player on the CD/DVD |
| 46 | Entry area (lead-in) of a music CD |
| 48 | Exit area (lead-out) of a CD |
| 50 | Chain of pits and land on a CD groove |
| 52 | Digital signal after transformation of pits/lands by an AD converter |
| 54 | Linear chain of bits, resulting from the digital signal |
| 55 | Segmented representation of EFM data with 3 merging-bits |
| 56 | Representation of byte data in an 8 in 14 modulation |
| 58 | Byte data (8 bit), which are corrected for bit errors and which can be passed on to |
| | additional error detection and correction units |
| 60 | Individual pit on a CD/DVD |
| 62 | Length of a pit on a CD |
| 64 | Distance between 2 grooves on a CD |
| 65 | Groove of a CD, where pits and lands are arranged one after the other |
| 66 | Width of a pit on a CD |
| 68 | Diameter of a focused laser beam of a CD player |
| 70 | Lands on a CD/DVD |
| 71 | Defect-like signal element on the groove of a CD |
| 72 | Defect-like signal element between the grooves of a CD |
| 73 | Defect-like signal element in the vicinity of a pit, thus at its beginning or end, |
| | respectively |
| 75 | Rotation direction of a CD |
| 80 | Frame, as smallest structured data unit of a CD, which is provided with an |
| | EDC/ECC-like error correction mechanism |
| 81 | Synchronization data area of a frame |
| 82 | Control byte of a frame, which is also designated as sub-code channel |
| 82p | P bit of a sub-code channel byte |
| 82q | Q bit of a sub-code channel byte |
| 82Q | 98 bit long bit field, consisting of the 82q bits of all frames of a sector |
| 84 | 1. user data area of a frame |
| 85 | 1^{st} level EDC/ECC error detection and correction area of a frame |
| 86 | 2. user data area of a frame |
| 87 | 2^{nd} level EDC/ECC error detection and correction area of a frame |
| 90 | Sector, which is composed of 98 frames as a data unit |
| 92 | Control data, which originate from the control bytes of the frames, which build a |
| | common sector |
| 93s | Synchronization bits from the 82Q bit chain |
| 93j | Type information for the content of the 82Q bit chain |
| 93k | Control bits from the 82Q bit chain |
| 93i | Data content bits from the 82Q bit chain |
| 93c | CRC error detection bit chain within the 82Q bit chain |
| 94 | User data area of a sector, which is combined from the user data areas (84), (85) |
| | of all frames which together form a sector |
| 95 | Combined 1^{st} level EDC/ECC data area of a sector, which is formed from the data |
| | areas (85) of all frames, which belong to a common sector |
| 97 | Combined 2^{nd} level EDC/ECC data area of a sector |
| 100 | Music track on a CD |
| 101 | Optional empty/free sectors between the music tracks |
| 102 | Sync data field of a CD-ROM mode 1 sector |
| 104 | Header data field of a CD-ROM mode 1 sector |
| 105 | User data field of a CD-ROM mode 1 sector, which consists of 2048 |
| | byte user data |
| 106 | CD-ROM mode 1 specific error detection and correction data, which secures the |
| | freedom from error of the user data in 105 |
| 110 | Sector assembly of a CD-ROM mode 1 data unit |
| 120 | Merging unit; means for bringing together of digital documents and of additional |
| | code data, which are inserted within the logical structure of the document format |
| 122 | Generating unit; means for producing data media units |
| 124 | Post-processing unit; means for later application of additional code data |
| 125 | Music data storage unit; means for storage of the digital document |
| 126 | Unit for generating review parameter |
| 130 | Generating unit for additional code data |
| 132 | Parameter data storage unit; means for storing parameter data, which are either |
| | generated by the unit (130) or are transmitted to the unit (130) for generating |
| | additional code data |
| 135 | Input unit; means for input of additional code data during production for the |
| | purpose of management or for the management of rights or such |
| 140 | Session management; means for management of various user queries and data |
| | requests |
| 142 | Data input station; means for request of additional code data and for input of |
| | additional data to the management, for determining user rights or such |
| 144 | Output unit for additional data; means for reception, conversion and automatic |
| | transmission of data |
| 145 | Firewall; means for protection of confidential and secret data |
| 146 | User management |
| 148 | User access management; means for release to a user by means of characteristics |
| | such as password or such |
| 150 | Generating unit; means for generating additional code data |
| 152 | Certification unit; means for digital signature of |
| | digital data for increasing the capacity for proof |
| 154 | Encryption generating and user unit; means for generating private/public |
| | encryption pairs, as well as the use of encryption on digital data |
| 155 | Data storage unit; means for storage of data, which are directly related to the |
| | creation of additional code |
| 160 | Certified log-file output unit; means for output of data, which are provided with a |
| | (qualified) digital signature |
| 162 | External monitoring unit; means for direct (video) monitoring of all security |
| | related equipment |
| 164 | Log-file generator; means for generating of important user-side data input or |
| | automatic status notification |
| 165 | Configuration management; means for configuration of the components in a |
| | production unit |
| 170 | Watermark data; additional code data, which cannot be detected as data and can |
| | be hidden in other data |
| 170a | Watermark data on a CD; additional code data, which are hidden on a data media |
| | in additional data resulting from accidental error data |
| 171 | Digital data with additional code without which the additional accidental error |
| | data, namely during use of error correction, can be generated |
| 172 | Digital data with additional code and a multitude of accidental error data, which |
| | can be regarded as white noise |
| 175 | White noise; additional data afflicted with errors, which become visible on the |
| | data media due to the missing error correction |
| 180 | Serial number data and encrypted data; data, which are contained on data media at |
| | defined locations/sectors/positions preferably in a connected manner, and which |
| | can be read with knowledge of the respective parameters and can be identified as |
| | serial number data or such |
| 180a | Serial number data and encrypted data on a CD without use of error correction; |
| | additional code data, which are hidden on data media in other data with errors |
| 185 | Driver interface; interface for accessing data from data media |
| 186 | Means for error correction; means implemented as software |
| 187 | Means for error correction; means implemented as software |
| 188 | Means for error correction; means implemented as hardware |
| 189 | Means for error correction; means implemented as hardware |
| 190a | Reading of data media data with only software-based error detection and |
| | transmission of data into the driver interface (185) in un-corrected form |
| 190b | Reading of data media data with only hardware-based error detection and |
| | transmission of data into the driver interface (185) in un-corrected form |
| 200 | Device for filtering of white noise of data, which are read by data media |
| 202 | Illustration of data of a data media unit after filtering of white noise |
| 204 | Additional code data, which are contained on a data media illustration purged of |
| | white noise |
| 205 | Device for separating of code data into independent review criteria |
| 207 | Interstice for recording of parameters, which can characterize the watermark |
| 208 | Interstice for recording serial number data |
| 209 | Interstice for recording of additional data as parameterized values |
| 210 | Table with independent review criteria |
| 215 | Data storage for parameters, drivers and processes, which are used in the units |
| | (200), (205) and (210) |
| 222 | Process step: input of a character chain |
| 224 | Process step: input, generation and insertion of serial number data |
| 226 | Process step: selection of the used encryptions, with which the additional code |
| | data can be generated and instantiated or use of the standard encryption |
| 228 | Process step: selection of rules for generating the additional code, for applying the |
| | code and for determining the verification process or use of the respective standard |
| | rules |
| 230 | Process step: calculation of the watermark with the values or processes, |
| | respectively, selected in (222)-(228), set or input as standard values |
| 232 | Process step: selection of an application prototype |
| 234 | Process step: creation of the total amount of additional code data including |
| | positioning data |
| 236 | Process step: combining the additional code data with the data of the electronic |
| | document including modulation by a code table or such, and the creation of the |
| | logical structure to be applied to the data media |
| 238 | Process step: test of the application and the implementation of verification for |
| | review of correctness |
| 240 | Process step: reading of the additional code data and of the data generated by |
| | white noise |
| 242 | Process step: selection of the verification process and verification criteria or use |
| | of standard values |
| 246 | Process step: selection of the serial number extraction process or use of the |
| | standard process |
| 248 | Process step: extraction of the watermark according to the selected process |
| 250 | Process step: extraction of the serial number and/or additional encrypted codes |
| | according to the selected process |
| 252 | Process step: verification, if watermark corresponds to serial number or other |
| | additional data within the verification criteria |
| 254 | Process step: output of review results |
| 260 | Means for offering, using and selecting various encryption data |
| 262 | Means for offering, using and selecting various processes for generating |
| | watermarks, serial number and other (encrypted) additional data |
| 264 | Means for offering, using and selecting various processes for calculating the |
| | application points or application prototype |
| 266 | Data storage for output/storage of various output templates |
| 268 | Means for offering, using and selecting various output templates |
| 270 | Production-side communications interface for mobile stations |
| 275 | Communications interface with the server |
| 280 | Data storage for storing various archiving templates, watermark-, serial number- |
| | and additional data extraction processes, parameters and encryptions; data storage |
| | for special drivers, verification processes and output templates |
| 282 | Means for offering, using and selecting various processes for verification and for |
| | use on and from the review criteria |
| 284 | Means for offering, using and selecting various processes for extraction of |
| | watermarks and serial numbers |
| 286 | Means for offering, using and selecting various drivers |
| 288 | Means for offering, using and selecting various output templates |
| 290 | Management unit for control of offering, using, selecting and updating of data in |
| | the data storage and for communicating with the user. |

1. Device for copy protection of data media units (10) carrying digital documents, especially of optically readable data media, with
means for applying a digital content (2) of the digital document onto the data media unit in a physical or logical structure associated with the data media unit
and means for applying additional code (3) onto the data media unit by predetermined change of the physical structure, so that during a regulated playback and/or display process of the digital data media unit by a regulation playback and/or display unit (15) the additional code is not captured and has no influence on the originating or displayed digital content of the digital document,
characterized by verification means being provided for recognition of a legally produced specimen of the data media unit, which, by bypassing possible error correction or filtering units in the playback or display unit provided for a data media unit, enable immediate reader access to the additional code and makes it possible to determine, if the additional code is present and if it corresponds to the additional code applied by the application means.

2. Device according to claim 1, characterized by the means for applying the additional code being formed in such a way, that it undertakes predetermined digital changes within the logical structure, within one of the structure-inherent redundancy areas, where the predetermined digital changes are placed in such a way, that an error correction or filtering does not influence the digital content of the electronic document.

3. Device according to claim 1, characterized by means for applying the additional code (3) being formed in such a way, that they create additional data as predetermined changes of one of more of the following types:
additional data contained in user data fields of a CD or DVD,
additional data contained in control fields (sub-code) of a CD or DVD,
additional data deposited in redundant EFM-like byte representations on a CD or DVD,
additional date deposited in FDC-FCC correction fields,
additional data placed in a lead-in-lead-out area of a CD or DVD,
for changes of header, user or control data in a predetermined way.

4. Device according to claim 1, characterized by the means for applying the additional code being formed in such a way, that they undertake predetermined changes in the physical structure outside of the logical structure in the form of data media identifiers corresponding to non-standardized measurements, selected from the group consisting of defect-like signal elements, and detect defect-like signal elements inherent in the physical structure, where the data media identifiers or signal elements, respectively, are formed in such a way, that an error correction or filtering does not influence the digital content of the electronic document.

5. Device according to claim 1, characterized by the means for applying additional code (3) being formed in such a way, that they create additional data for modification of at least one of a frame-, and/or sector- and track arrangement of a CD or DVD as additional code.

6. Use of the device according to claim 1 for copy protection of digital documents on CDs, DVDs and digital tape media.

7. Process for the production of a data media unit carrying digital documents, utilizing a device according to claim 1, characterized by the steps:
reading of the digital content of a digital document from a data media unit;
creating data of additional code and depositing the data into a code storage unit;
applying the digital content onto the data media unit and
applying the additional code onto the data media unit,
where the data of the additional code are created in such a way, that they change the physical and/or logical structure associated with the data media unit in such a way, that, during a regulation playback and/or display process of the digital data media unit by a regulation playback and/or display unit for the data media unit, the additional code is not captured and has no influence on the originating or displayed digital content of the digital document.

8. Process according to claim 7, characterized by the application of the digital content onto the data media unit occurring before or after the application of the additional code, in the form of two separate production steps.

9. Process according to claim 7, characterized by the application of digital content taking place together with the application of additional code, where by means of an application unit physically affecting the data media unit a common data set, containing the data of the digital document and data of additional code, is applied, in a single work process.

10. Process according to claim 1 for production of a CD or DVD carrying digital documents, characterized by the step of applying the additional code showing the physical change of a signal code on a matrix used for production of the CD or DVD, the immediate change of a signal code on the produced CD or DVD itself within a logical data structure of the CD or DVD, or the immediate change of the signal structure of the CD or DVD outside of the logical structure of the CD or DVD.

11. Process for verification of a data media unit carrying the digital document, utilizing device according to claim 1, characterized by the additional code not being acquired due to the step of acquisition of additional code on a data media unit, which is formed by predetermined change of the physical and logical structure of the data media unit in such a way, that during regular playback and display process of the digital data media unit by a regular playback or display provided for the data media unit, and having no influence on the output or display of digital content of the digital document, and
executing a number of digital calculation operations on the data of the acquired additional code for obtaining a number of digital watermarks, which are different from one another.

12. Process according to claim 13, characterized by the step of additional linkage of at least one of the calculated digital watermarks with an individualized identifier of the data media unit, where the individual identifier is correlated with the watermark in the form of a serial number by a private/public key process.

13. Device according to claim 1, characterized by means for communication or operation control (9) of the playback or display unit being formed in such a way, that dependent on the determination of output signals as a reaction, certain playback, display, copying or data transmission modes of the playback or display unit can be activated or suppressed.

14. Device according to claim 1, characterized by the means for application of additional code being formed in such a way, that the additional digital code contains information about user rights or user right limitations associated with the electronic document.
